(19) United States
(12) Patent Application Publication
(10) Pub. No.: US 2009/0288739 A1
(43) Pub. Date: Nov. 26, 2009

(54) BINDER-COMPRISING THERMOPLASTIC COMPOSITIONS FOR PRODUCING SHAPED METALLIC BODIES

(75) Inventors: Hans Wohlfromm, Mannheim (DE); Jens Assmann, Mannheim (DE); Johan Herman Hendrik ter Maat, Mannheim (DE); Martin Blömacher, Meckenheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/373,439

(22) PCT Filed: Jul. 5, 2007
(86) PCT No.: PCT/EP07/56857

§ 371 Date: Jan. 12, 2009

(30) Foreign Application Priority Data
Jul. 13, 2006 (EP) 06117157.5

(51) Int. Cl. C08K 5/1575; C21B 15/00

(52) U.S. Cl. 148/522; 523/139

(57) ABSTRACT

The present invention relates to binders for pulverulent metals or pulverulent metal alloys, thermoplastic compositions comprising these binders for producing shaped metallic bodies, a process for producing them, their use and a process for producing shaped bodies therefrom.

The present invention relates to binders for pulverulent metals or pulverulent metal alloys, thermoplastic compositions comprising these binders for producing shaped metallic bodies, a process for producing them, their use and a process for producing shaped bodies therefrom.

Shaped metallic bodies can be produced by injection molding of thermoplastic compositions comprising metal powders together with an organic binder. These are highly filled organic polymer molding compositions. After injection molding, extrusion or pressing of the thermoplastic composition to form a green body, the organic binder is removed and the resulting green body which has been freed of binder is sintered.

EP-A 0 465 940 relates to thermoplastic compositions of this type for producing shaped metallic bodies, which compositions comprise a sinterable pulverulent metal or a pulverulent metal alloy or mixtures thereof together with a mixture of polyoxymethylene homopolymers or copolymers and a polymer which is immiscible therewith as binder. Possible additional polymers are polyolefins, in particular polyethylene and polypropylene, and also polymers of methacrylic esters such as PMMA. Binder removal can be effected by treatment in a gaseous acid-comprising atmosphere at elevated temperature, resulting in depolymerization of the polyoxymethylene homopolymers or copolymers, followed by a thermal removal of the residual immiscible polymer.

DE 100 19 447 A1 describes binders for inorganic material powders for producing shaped metallic or ceramic bodies. These binders comprise a mixture of polyoxymethylene homopolymers or copolymers and a polymer system comprising polytetrahydrofuran and at least one polymer of C₂₋₈-olefins, vinylaromatic monomers, vinyl esters of aliphatic C₁₋₈-carboxylic acids, vinyl C₁₋₈-alkyl ethers or C₁₋₁₂-alkyl (meth)acrylates.

DE-A 40 00 278 relates to a process for producing an inorganic shaped sintered part. For this purpose, a mixture of a sinterable inorganic powder and polyoxymethylene as binder is shaped to give a green body. The binder is removed by treatment of the green body with a gaseous atmosphere comprising boron trifluoride. The green body which has been treated in this way is subsequently sintered. Examples of sinterable powders are oxidic ceramic powders such as Al₂O₃, ZrO₂, Y₂O₃, and also nonoxidic ceramic powders such as SiC, Si₃N₄.

In the production of shaped metallic bodies using the binders known from the prior art, demixing problems frequently occur, particularly in the vicinity of the sprue, which subsequently have to be polished away.

Furthermore, stress cracks which only become visible after sintering and represent defects in the shaped bodies can occur.

A further disadvantage of the known binders can be their not always satisfactory flowability when they have been processed to give highly filled thermoplastic compositions. Unsatisfactory filling of the mold can sometimes occur as a result, especially in the case of complex injection-molded parts.

It is therefore an object of the invention to provide an improved binder for pulverulent metal powders which avoids the disadvantages of the known binders. The dimensional stability of the components should be retained on binder removal. In addition, a high binder removal rate should also be ensured.

This object is achieved according to the invention by a binder B) for pulverulent metals or metal alloys or mixtures thereof, which comprises a mixture of
B₁) from 50 to 96% by weight of one or more polyoxymethylene homopolymers or copolymers;
B₂) from 2 to 35% by weight of one or more polyolefins;
B₃) from 2 to 40% by weight of poly-1,3-dioxepane or poly-1,3-dioxolane or mixtures thereof,
   where the proportions by weight of the components B₁, B₂ and B₃ add up to 100%.

According to the invention, it has been found that as a result of the use of the three binder components B₁), B₂) and B₃), this binder has improved flowability and can be removed without leaving a residue during binder removal. It is thus possible for, in particular, injection-molded bodies having complex shapes to be produced and freed of binder without problems.

The individual components of the binder B) are described in more detail below.

As component B₁) use is made of polyoxymethylene homopolymers or copolymers in an amount of from 50 to 96% by weight, preferably from 60 to 90% by weight, particularly preferably from 70 to 85% by weight, based on the total amount of the binder B.

The polyoxymethylene copolymers (POMs) are known per se and are commercially available. They are usually prepared by polymerization of trioxane as main monomer; comonomers are used in addition. The main monomers are preferably selected from among trioxane and other cyclic or linear formals or other formaldehyde sources.

The term main monomers is intended to indicate that the proportion of these monomers in the total amount of monomers, i.e. the sum of main monomers and comonomers, is greater than the proportion of the comonomers in the total amount of monomers.

Such POM polymers quite generally have at least 50 mol % of recurring —CH₂O— units in the main polymer chain. Suitable polyoxymethylene copolymers are, in particular, those which comprise not only the recurring —CH₂O— units but also up to 50 mol %, preferably from 0.01 to 20 mol %, in particular from 0.1 to 10 mol % and very particularly preferably from 0.5 to 6 mol %, of recurring

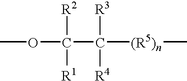

units, where R¹ to R⁴ are each, independently of one another, a hydrogen atom, a C₁-C₄-alkyl group or a halogen-substituted alkyl group having from 1 to 4 carbon atoms and R⁵ is a —CH₂— group, a —CH₂O— group, a C₁-C₄-alkyl- or C₁-C₄-haloalkyl-substituted methylene group or a corresponding oxymethylene group and n is in the range from 0 to 3. These groups can advantageously be introduced into the copolymers by ring opening of cyclic ethers. Preferred cyclic ethers are those of the formula

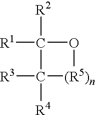

where R¹ and R⁵ and n are as defined above. Mention may be made, purely by way of example, of ethylene oxide, 1,2-propylene oxide, 1,2-butylene oxide, 1,3-butylene oxide, 1,3-dioxane, 1,3-dioxolane and 1,3-dioxepane as cyclic ethers and also linear oligoformals or polyformals such as polydioxolane or polydioxepane as comonomers. 1,3-Dioxolane and 1,3-dioxepane are particularly preferred comonomers. Very particular preference is given to 1,3-dioxepane.

Also suitable are oxymethylene terpolymers which are prepared, for example, by reaction of trioxane and one of the above-described cyclic ethers with a third monomer, preferably bifunctional compounds of the formula

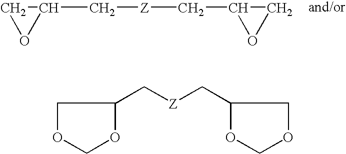

where Z is a chemical bond, —O—, —ORO— (R═C₁-C₈-alkylene or C₃-C₈-cycloalkylene), as described in EP-A 0 465 940.

Preferred monomers of this type are ethylene diglycide, diglycidyl ether and diethers derived from glycidyls and formaldehyde, dioxane or trioxane in a molar ratio of 2:1 and also diethers derived from 2 mol of glycidyl compound and 1 mol of an aliphatic diol having from 2 to 8 carbon atoms, for example the diglycidyl ethers of ethylene glycol, 1,4-butanediol, 1,3-butanediol, cyclobutane-1,3-diol, 1,2-propanediol and cyclohexane-1,4-diol, to name only a few examples.

End-group-stabilized polyoxymethylene polymers which have predominantly C—C or —O—CH₃— bonds at the ends of the chain are particularly preferred.

The preferred polyoxymethylene copolymers have melting points of at least 150° C. and molecular weights (weight average) M_{w} in the range from 5000 to 300 000, preferably from 6000 to 150 000, particularly preferably in the range from 7000 to 60 000. Particular preference is given to POM copolymers having a polydispersity (M_{w}/Mₙ) of from 2 to 15, preferably from 2.5 to 12, particularly preferably from 3 to 9. The measurements are generally carried out by gel permeation chromatography (GPC)/SEC (size exclusion chromatography), and the Mₙ (number average molecular weight) is generally determined by means of GPC/SEC.

Methods of preparing polyoxymethylene homopolymers and copolymers are known to those skilled in the art.

Component B₂) comprises polyolefins or mixtures thereof in an amount of from 2 to 35% by weight, preferably from 3 to 20% by weight, particularly preferably from 4 to 15% by weight, based on the total amount of the binder B).

As polyolefins, mention may be made of those having from 2 to 8 carbon atoms, in particular from 2 to 4 carbon atoms, and also their copolymers. Particular preference is given to polyethylene and polypropylene and also their copolymers as are known to those skilled in the art and are commercially available, for example under the trade name Lupolen® or Novolen® from BASF AG.

The polymers of the component B₂) can be prepared by polymerization processes known per se, preferably free-radical polymerization, for example by emulsion, bead, solution or bulk polymerization. Possible initiators are, depending on the monomers and the type of polymerization, free-radical initiators such as peroxy compounds and azo compounds with the amounts of initiator generally being in the range from 0.001 to 0.5% by weight, based on the monomers. Suitable polymerization processes are described in EP-A-0 465 940.

Polymers suitable as component B₃) are poly-1,3-dioxepane —O—CH₂—O—CH₂—CH₂—CH₂—CH₂—, poly-1,3-dioxolane —O—CH₂—O—CH₂—CH₂— or mixtures thereof in an amount of from 2 to 40% by weight, preferably from 5 to 30% by weight, particularly preferably from 10 to 26% by weight, based on the total amount of the binder B. Owing to its rapid depolymerization under acid conditions, poly-1,3-dioxepane is particularly preferred.

Poly-1,3-dioxepane and poly-1,3-dioxolane can be prepared by methods analogous to those for polyoxymethylene homopolymers or copolymers, so that further details are superfluous here. The molecular weight (weight average) is in the range from 10 000 to 150 000, preferably (in the case of poly-1,3-dioxepane) in the range from 15 000 to 50 000, particularly preferably (in the case of poly-1,3-dioxepane) in the range from 18 000 to 35 000) and preferably (in the case of poly-1,3-dioxolane) from 30 000 to 120 000, particularly preferably (in the case of poly-1,3-dioxolane) from 40 000 to 110 000.

Under the conditions of compounding or processing by injection molding, virtually no transacetalization occurs between the polyoxymethylene polymers B₁) and B₃), i.e. virtually no exchange of comonomer units takes place.

The binders B) of the invention are used in thermoplastic compositions for producing shaped metallic bodies.

The invention therefore also provides thermoplastic compositions for producing shaped metallic bodies, which comprise
A) from 40 to 70% by volume, preferably from 45 to 65% by volume, particularly preferably from 50 to 60% by volume, of a sinterable pulverulent metal or a sinterable pulverulent metal alloy or mixtures thereof,
B) from 30 to 60% by volume, preferably from 35 to 55% by volume, particularly preferably from 40 to 50% by volume, of a mixture of
   B₁) from 50 to 96% by weight, preferably from 60 to 90% by weight, particular preferably from 70 to 85% by weight, of one or more polyoxymethylene homopolymers or copolymers, preferably a polyoxymethylene copolymer comprising from 0.01 to 20 mol % of 1,3-dioxepane or 1,3-dioxolane as comonomer;
   B₂) from 2 to 35% by weight, preferably from 3 to 20% by weight, particularly preferably from 4 to 15% by weight, of one or more polyolefins, preferably polyethylene;
   B₃) from 2 to 40% by weight, preferably from 5 to 30% by weight, particularly preferably from 10 to 26% by weight, of poly-1,3-dioxepane or poly-1,3-dioxolane or mixtures thereof, preferably poly-1,3-dioxepane,
as binder, where the proportions by weight of the components B₁), B₂) and B₃) add up to 100%, and
C) from 0 to 5% by volume of a dispersant,
   where the amount of the components A), B) and C) add up to 100% by volume.

As metals which can be present in powder form, mention may be made of, for example, aluminum, iron, in particular iron carbonyl powder, cobalt, copper, nickel, silicon, titanium and tungsten. As pulverulent metal alloys mention may be made of, for example, high- or low-alloy steels and also metal alloys based on aluminum, iron, titanium, copper, nickel, cobalt or tungsten. It is possible here to use either powders of finished alloys or powder mixtures of the individual alloy constituents. The metal powders, metal alloy powders and metal carbonyl powders can also be used in admixture.

The particle sizes of the powders are preferably from 0.1 to 80 μm, particularly preferably from 1.0 to 50 μm.

Owing to the high flowability of the binder of the invention, high loading of the binder with the powder A) is possible without the flowability being decreased too much.

The dispersant which may, if appropriate, be present as component C) can be selected from among known dispersants. Examples are oligomeric polyethylene oxide having a mean molecular weight of from 200 to 600, stearic acid, stearamide, hydroxystearic acid, fatty alcohols, fatty alcohol sulfonates and block copolymers of ethylene oxide and propylene oxide, and also particularly preferably polyisobutylene. Particular preference is given to using polyisobutylene in an amount of from 1 to 6% by volume, based on the components A), B) and C).

In addition, the thermoplastic compositions can further comprise customary additives and processing aids which have an advantageous influence on the rheological properties of the mixtures during shaping.

The thermoplastic compositions of the invention are, according to the invention, produced by melting the component B) and mixing in the components A) and, if appropriate, C). For example, the component B) can be melted in a twin-screw extruder at temperatures of preferably from 150 to 220° C., in particular from 170 to 200° C. The component A) is subsequently metered in the required amount into the melt stream of the component B) at temperatures in the same range. The component A) advantageously comprises the dispersant or dispersants C) on the surface. However, the thermoplastic compositions of the invention can also be produced by melting the components B) and C) in the presence of the component A) at temperatures of from 150 to 220° C.

A particularly preferred apparatus for metering the component A) comprises as essential element a transport screw which is located in a heatable metal cylinder and transports the component A) into the melt of the component B). The above-described process has the advantage over mixing of the components at room temperature and subsequent extrusion with an increase in temperature that decomposition of the polyoxymethylene used as binder as a result of the high shear forces occurring in this variant is largely avoided.

The thermoplastic compositions of the invention can be used for producing shaped metallic bodies of the powder A).

The present invention therefore also provides a process for producing shaped bodies from the above-described thermoplastic compositions by
a) shaping the thermoplastic composition by injection molding, extrusion or pressing to form a green body,
b) removing the binder by treating the green body with a gaseous acid-comprising atmosphere at a temperature in the range from 20 to 180° C. for from 0.1 to 24 hours,
c) subsequently heating the green body at a temperature in the range from 250 to 600° C. for from 0.1 to 12 hours and
d) subsequently sintering the resulting green body which has been freed of binder in this way.

For shaping by injection molding, it is possible to use the customary screw and piston injection-molding machines. Shaping is generally carried out at temperatures of from 175 to 200° C. and pressures of from 3000 to 20 000 kPa in molds which have a temperature of from 60 to 120° C.

Extrusion to produce tubes, rods and profiles is preferably carried out at temperatures of from 170 to 200° C.

To remove the binder, the green bodies obtained after shaping are treated with a gaseous, acid-comprising atmosphere. Appropriate processes are described, for example, in DE-A 39 29 869 and DE-A 40 00 278. This treatment is, according to the invention, preferably carried out at temperatures in the range from 20 to 180° C. for a period of preferably from 0.1 to 24 hours, preferably from 0.5 to 12 hours.

Suitable acids for the treatment in this first step of the process of the invention are, for example, inorganic acids which are either gaseous at room temperature or can be vaporized at the treatment temperature or below. Examples are hydrogen halides and nitric acid. Suitable organic acids are those which have a boiling point at atmospheric pressure of less than 130° C., e.g. formic acid, acetic acid, oxalic acid or trifluoroacetic acid and mixtures thereof.

Furthermore, BF₃ and its adducts with inorganic ethers can be used as acid. The treatment time required depends on the treatment temperature and the concentration of the acid in the treatment atmosphere and also on the size of the shaped body.

If a carrier gas is used, this is generally passed through the acid and loaded with this beforehand. The carrier gas which has been loaded in this way is then brought to the treatment temperature which is advantageously higher than the loading temperature in order to avoid condensation of the acid. Preference is given to mixing the acid into the carrier gas by means of a metering device and heating the mixture to such a temperature that the acid can no longer condense.

The acid treatment is preferably continued until the polyoxymethylene component of the binder has been removed to an extent of at least 80% by weight, preferably at least 90% by weight. This can be checked, for example, with the aid of the weight decrease. The product obtained in this way is subsequently heated for preferably from 0.1 to 12 hours, particularly preferably from 0.3 to 6 hours, at a temperature of preferably from 250 to 700° C., particularly preferably from 250 to 600° C., to remove the residual binder completely.

The product which has been freed of the binder in this way can be converted in a customary manner by sintering into the desired shaped body, in particular shaped metallic or ceramic body.

The thermoplastic compositions of the invention have, in addition to the residue-free binder removal, the high flowability and the high loadability with the powders A), the further advantage that the green bodies or shaped metallic or ceramic bodies produced therefrom are free of cracks and pores even at high wall thicknesses. An additional advantage is that the removal of the binder can be carried out in two stages. The polyoxymethylene is firstly removed at relatively low temperatures by hydrolytic degradation, with the major part of the polymer system B₂) remaining. The products then obtained (brown bodies) are relatively stable and can be handled or transported without problems. The removal of the remainder of the polymer system B₂) can then be effected at elevated temperatures.

The invention is illustrated below with the aid of examples in which various polyoxymethylene-comprising binders were used for the thermoplastic compositions.

### EXAMPLE 1

The composition 1B was made up of the following:

56.7% by volume of a mixture of 92% by weight of carbonyl iron powder and 8% by weight of carbonyl nickel powder
43.3% by volume of binder comprising 79.7% by weight of polyoxymethylene with 2 mol % of 1,3-dioxepane; 4.4% by weight of polyethylene and 15.9% by weight of poly-1,3-dioxepane.

### EXAMPLE 2

The second composition 2B was made up of the following:

56.7% by volume of a mixture of 92% by weight of carbonyl iron powder and 8% by weight of carbonyl nickel powder
43.3% by volume of binder comprising 75.3% by weight of polyoxymethylene with 2 mol % of 1,3-dioxepane; 8.4% by weight of polyethylene and 16.3% by weight of polydioxolane.

### EXAMPLE 3

The third composition 3B was made up of the following:

56.7% by volume of a mixture of 92% by weight of carbonyl iron powder and 8% by weight of carbonyl nickel powder
43.3% by volume of binder comprising 70.0% by weight of polyoxymethylene with 2 mol % of 1,3-dioxepane; 10.0% by weight of polyethylene and 20.0% by weight of poly-1,3-dioxepane.

### EXAMPLE 4

The fourth composition 4B was made up of the following:

57.5% by volume of a mixture of 92% by weight of carbonyl iron powder and 8% by weight of carbonyl nickel powder
42.5% by volume of binder comprising 67.1% by weight of polyoxymethylene with 2 mol % of 1,3-dioxepane; 7.5% by weight of polyethylene and 25.4% by weight of poly-1,3-dioxepane.

### EXAMPLE 5

### Comparative Example

The fifth composition 5B was made up of the following:

56.2% by volume of a mixture of 92% by weight of carbonyl iron powder and 8% by weight of carbonyl nickel powder
43.8% by volume of binder comprising 89.9% by weight of polyoxymethylene with 2 mol % of 1,3-dioxepane and 10.1% by weight of polyethylene.

### EXAMPLE 6

### Comparative Example

The sixth composition 6B was made up of the following:

56.2% by volume of a mixture of 92% by weight of carbonyl iron powder and 8% by weight of carbonyl nickel powder
43.8% by volume of binder comprising 92.6% by weight of polyoxymethylene with 2 mol % of 1,3-dioxepane; 5.1% by weight of polyethylene and 2.3% by weight of polytetrahydrofuran.

### EXAMPLE 7

### Comparative Example

The seventh composition 7B was made up of the following:

56.2% by volume of a mixture of 92% by weight of carbonyl iron powder and 8% by weight of carbonyl nickel powder
43.8% by volume of binder comprising 80% by weight of polyoxymethylene with 2 mol % of 1,3-dioxepane and 20% by weight of poly-1,3-dioxpane.

The formulations 1 to 7 were produced in a twin-screw extruder having a screw diameter of 30 mm and a speed of rotation of the screws of 70 rpm. About 5.6 kg/h of the binder preparation which had been melted at 180° C. were fed into the extruder. 40 kg/h of the iron/nickel powder were metered in via a second extruder which was flanged on at the side of the first extruder and was equipped with a transport helix for powder and the iron/nickel powder was heated to 170° C. by the end of the transport section.

At the end of the transport section, the metal powder was mixed with the polymeric binder, the mixture was sheared, homogenized and pressed as strands through die orifices. The strands were cooled in a stream of air and palletized. The pellets obtained in this way comprised about 56% by volume of a mixture of 92% by weight of carbonyl iron powder and 8% by weight of carbonyl nickel powder.

### Examination of the Flowability

To make possible a very close-to-practice comparison of the flowability and thus the processability of the thermoplastic compositions according to the invention, part of the above compositions were tested by means of a flow spiral. This is a tool having a spiral flow path. This injection-molding tool was injected on a commercial injection-molding machine (Engel cc 90) under standard conditions. The tool was heated to a temperature T of 132° C. (T<the melting point of the binder) and the injection conditions such as barrel and die temperature, plasticization time, injection speed and tool temperature were kept unchanged in order to be able to determine the distance traveled by the material under identical conditions. This distance traveled (in cm) is thus a close-to-practice test for the flowability of the material under production conditions. At the end of the flow spiral, more or less pronounced, depending on the composition, demixing phenomena are apparent. The length and degree of these demixing phenomena were employed as a qualitative measure to describe the demixing tendency of the molding compositions. The results are summarized in Table 1 below.

TABLE 1

| | | Flow | |
|---|---|---|---|
| | Composition of | distance | |
| Example | binder | [cm] | Demixing |
| 1 | POM (2% mol of 1,3-dioxepane); PE; | 25 | slight |
| | 1,3-polydioxepane | | |
| 2 | POM (2% mol of 1,3-dioxepane); PE; | 24 | slight |
| | 1,3-polydioxolane | | |
| 3 | POM (2% mol of 1,3-dioxepane); PE; | 27 | slight |
| | 1,3-polydioxepane | | |
| 4 | POM (2% mol of 1,3-dioxepane); PE; | 27 | slight |
| | 1,3-polydioxepane | | |
| 5 | POM (2% mol of 1,3-dioxepane); PE; | 18 | very |
| | | | pronounced |
| 6 | POM (2% mol of 1,3-dioxepane), PE; | 22 | pronounced |
| | PTHF | | |
| 7 | POM (2% mol of 1,3-dioxepane); | 23 | pronounced |
| | 1,3-polydioxepane | | |

The results show that the distance which the molding compositions based on POM-polyethylene-polydioxepane and POM-polyethylene-polydioxolane flow is significantly improved compared to the comparative examples; in addition, the demixing tendency is reduced.

### Injection Molding Experiments on Real Components

A significant improvement in the processability in injection molding could also be achieved on real components under conditions similar to production when using the thermoplastic compositions according to the invention. In particular, a wider processing window was observed: in particular, the tool temperature can be chosen in a wider temperature range. Demixing as is frequently observed, in particular in the vicinity of the sprue, occurred to a significantly lesser degree when using the molding compositions from examples 1 to 4 than in the case of comparative examples 5 to 7. While stress cracks were occasionally observed on critical components when using the molding compositions from the comparative examples, the moldings produced from the compositions from examples 1 to 4 were crack-free in every case.

### Examination of the Surface Roughness

After binder removal and sintering, demixing leads to surface roughness which, particularly in the case of visible parts, e.g. in consumer articles, makes laborious further working by polishing necessary. Small plates were injection molded from the abovementioned molding compositions of examples 1 to 7 and these were subsequently subjected to binder removal and sintered. The maximum roughness profile height Rz was then determined in accordance with DIN EN ISO 4287 in a region of 8×13 mm in the vicinity of the sprue. The mean Rz values are shown in Table 2.

TABLE 2

| | Composition of | Rz |
|---|---|---|
| Example | binder | (μm) |
| 1 | POM (2 mol % of 1,3-dioxepane); PE; | 2.2 |
| | 1,3-polydioxepane | |
| 2 | POM (2 mol % of 1,3-dioxepane); PE; | 2.0 |
| | 1,3-polydioxolane | |
| 3 | POM (2 mol % of 1,3-dioxepane); PE; | 2.3 |
| | 1,3-polydioxolane | |
| 4 | POM (2 mol % of 1,3-dioxepane); PE; | 2.4 |
| | 1,3-polydioxepane | |
| 5 | POM (2 mol % of 1,3-dioxepane); PE; | 3.5 |
| 6 | POM (2 mol % of 1,3-dioxepane), | 3.2 |
| | polyethylene, PTHF | |
| 7 | POM (2 mol % of 1,3-dioxepane); | 3.7 |
| | 1,3-polydioxepane | |

On the basis of experience, Rz values of ≦2.5 μm are an indication that a high-quality product which has a very smooth surface and satisfies, for example, the requirements for many consumer articles can be obtained from the sintered component with very little polishing. The molding compositions of examples 1 to 4 display Rz values of ≦2.5 μm and thus offer a considerable advantage in the production of components having a high quality of the surface.

Examination of the binder removal rate and the dimensional stability during removal of the binder

An important requirement which the improved formulation had to meet was to ensure a high binder removal rate and also dimensional stability during binder removal. To evaluate the behavior during binder removal, plates having a length of 48 mm, width of 15 mm and thickness of 6 mm were produced and placed on 2 rollers in a binder removal oven so that the distance between the rollers was 42 mm. The oven was firstly heated to 110° C. and flushed with 500 l/h of nitrogen for 30 minutes. 30 ml/h of 98% strength nitric acid were then metered in while maintaining the flushing with nitrogen. The introduction of acid was maintained for 2.5 hours; the oven was subsequently flushed with 500 l/h of nitrogen for 45 minutes and cooled to room temperature. Breaking of the parts and visual assessment demonstrated that the binder had been completely removed from all specimens from examples 1 to 7. The formulations according to the invention of examples 1 to 4 thus do not have any disadvantageous effect in respect of the binder removal rate. To evaluate the dimensional stability, the permanent deformation of the specimens was assessed. No measurable permanent deformation was observed on the plates produced from formulations of examples 1 to 6; plates from example 7 had broken under their own weight. This means that the formulations according to the invention are at least as dimensionally stable during binder removal as the formulations from comparative examples 5 and 6 and are significantly better than comparative example 7.

### Examination of the Green Strength and Brown Strength

The strength of components after injection molding (green strength) and after binder removal (brown strength) is of great importance for the further processing of MIM components: high green and brown strengths are an indication that the components can be handled without breaking and without problems in the further processing steps. To determine the green strength and brown strength, flexural bars having the dimensions 65×7×5 mm were injection molded and subjected to a 4-point bend test using a method based on DIN EN 843 (Part 1). To determine the brown strength, the flexural bars were subjected to catalytic binder removal (as described above) beforehand. The results are summarized in table 3 below:

TABLE 3

| | | Green | Brown |
|---|---|---|---|
| | Composition of | strength | strength |
| Example | binder | (MPa) | (MPa) |
| 1 | POM (2 mol % of 1,3-dioxepane); | 18.2 | 5.6 |
| | PE; 1,3-polydioxepane | | |
| 2 | POM (2 mol % of 1,3-dioxepane); | 16.6 | 5.3 |
| | PE; 1,3-polydioxolane | | |
| 3 | POM (2 mol % of 1,3-dioxepane); | 16.5 | 5.0 |
| | PE; 1,3-polydioxolane | | |
| 4 | POM (2 mol % of 1,3-dioxepane); | 16.4 | 5.1 |
| | PE; 1,3-polydioxepane | | |
| 5 | POM (2 mol % of 1,3-dioxepane); | 22.6 | 4.8 |
| | PE; | | |
| 6 | POM (2 mol % of 1,3-dioxepane), | 7.4 | 4.0 |
| | polyethylene, PTHF | | |
| 7 | POM (2 mol % of 1,3-dioxepane); | 6.5 | 1.2 |
| | 1,3-polydioxepane | | |

The results show that the green strength is at most slightly reduced by addition of polydioxepane or polydioxolane (examples 1 to 4). The green strength is even significantly better than in comparative examples 6 and 7. The brown strength is even somewhat improved.

1. A binder B) for pulverulent metals or metal alloys or mixtures thereof, which comprises
B₁) from 50 to 96% by weight of one or more polyoxymethylene homopolymers or copolymers;
B₂) from 2 to 35% by weight of one or more polyolefins;
B₃) from 2 to 40% by weight of poly-1,3-dioxepane or poly-1,3-dioxolane or mixtures thereof,
where the proportions by weight of the components B₁, B₂ and B₃ add up to 100%.

2. The binder according to claim 1, wherein the mixture comprises from 70 to 85% by weight of the component B₁), from 4 to 15% by weight of the component B₂), and from 10 to 26% by weight of the component B₃), where the proportions by weight of the components B₁, B₂ and B₃ add up to 100%.

3. The binder according to claim 1, wherein a polyoxymethylene copolymer comprising from 0.01 to 20 mol % of 1,3-dioxepane or 1,3-dioxolane as comonomer is present as component B₁), polyethylene is present as component B₂) and poly-1,3-dioxepane or poly-1,3-dioxolane is present as component B₃).

4. A thermoplastic composition for producing shaped metallic bodies, which comprises
A) from 40 to 70% by volume of a sinterable pulverulent metal or a sinterable pulverulent metal alloy or mixtures thereof,
B) from 30 to 60% by volume of a mixture of
B₁) from 50 to 96% by weight of one or more polyoxymethylene homopolymers or copolymers;
B₂) from 2 to 35% by weight of one or more polyolefins;
B₃) from 2 to 40% by weight of poly-1,3-dioxepane or poly-1,3-dioxolane or mixtures thereof
as binder, where the proportions by weight of the components B₁, B₂ and B₃ add up to 100%, and
C) from 0 to 5% by volume of a dispersant.

5. The thermoplastic composition according to claim 4, wherein the component B) comprises from 70 to 85% by weight of the component B₁), from 4 to 15% by weight of the component B₂), and from 10 to 26% by weight of the component B₃), where the proportions by weight of the components B₁, B₂ and B₃ add up to 100%.

6. The thermoplastic composition according to claim 4, wherein a polyoxymethylene copolymer comprising from 0.01 to 20 mol % of 1,3-dioxepane as comonomer is present as component B₁), polyethylene is present as component B₂) and poly-1,3-dioxepane or poly-1,3-dioxolane is present as component B₃).

7. A method of producing shaped metallic bodies comprising melting the thermoplastic composition defined according to claim 4.

8. A shaped metallic body produced from a thermoplastic composition defined according to claim 4.

9. A process for producing a thermoplastic composition comprising as significant components
A) from 40 to 70% by volume of a sinterable pulverulent metal or a sinterable pulverulent metal alloy or mixtures thereof,
B) from 30 to 60% by volume of a mixture of
B₁) from 50 to 96% by weight of one or more polyoxymethylene homopolymers or copolymers;
B₂) from 2 to 35% by weight of one or more polyolefins;
B₃) from 2 to 40% by weight of poly-1,3-dioxepane or poly-1,3-dioxolane or mixtures thereof
as binder, where the proportions by weight of the components B₁, B₂ and B₃ add up to 100%, and
C) from 0 to 5% by volume of a dispersant,
wherein
a₁) the component B) is melted at temperatures of from 150 to 220° C. and subsequently
b₁) the component A), if appropriate together with the component C), is metered into the melt stream of the component B) at temperatures in the same range as in step a) or
a₂) the components B) and C) are melted in the presence of the component A) at temperatures of from 150 to 220° C.

10. A process for producing shaped bodies from a thermoplastic composition defined according to claim 4 by
a) shaping the thermoplastic composition by injection molding, extrusion or pressing to form a green body,
b) removing the binder by treating the green body with a gaseous acid-comprising atmosphere at a temperature in the range from 20 to 180° C. for from 0.1 to 24 hours,
c) subsequently heating the green body at a temperature in the range from 250 to 600° C. for from 0.1 to 12 hours and
d) subsequently sintering the resulting green body which has been freed of binder in this way.

11. The binder according to claim 2, wherein a polyoxymethylene copolymer comprising from 0.01 to 20 mol % of 1,3-dioxepane or 1,3-dioxolane as comonomer is present as component B₁), polyethylene is present as component B₂) and poly-1,3-dioxepane or poly-1,3-dioxolane is present as component B₃).

12. The thermoplastic composition according to claim 5, wherein a polyoxymethylene copolymer comprising from 0.01 to 20 mol % of 1,3-dioxepane as comonomer is present as component B₁), polyethylene is present as component B₂) and poly-1,3-dioxepane or poly-1,3-dioxolane is present as component B₃).

13. A method of producing shaped metallic bodies comprising melting the thermoplastic composition defined according to claim 5.

14. A method of producing shaped metallic bodies comprising melting the thermoplastic composition defined according to claim 6.

15. A shaped metallic body produced from a thermoplastic composition defined according to claim 5.

16. A shaped metallic body produced from a thermoplastic composition defined according to claim 6.

17. A process for producing shaped bodies from a thermoplastic composition defined according to claim 5 by
a) shaping the thermoplastic composition by injection molding, extrusion or pressing to form a green body,
b) removing the binder by treating the green body with a gaseous acid-comprising atmosphere at a temperature in the range from 20 to 180° C. for from 0.1 to 24 hours,
c) subsequently heating the green body at a temperature in the range from 250 to 600° C. for from 0.1 to 12 hours and
d) subsequently sintering the resulting green body which has been freed of binder in this way.

18. A process for producing shaped bodies from a thermoplastic composition defined according to claim 6 by
a) shaping the thermoplastic composition by injection molding, extrusion or pressing to form a green body,
b) removing the binder by treating the green body with a gaseous acid-comprising atmosphere at a temperature in the range from 20 to 180° C. for from 0.1 to 24 hours,
c) subsequently heating the green body at a temperature in the range from 250 to 600° C. for from 0.1 to 12 hours and
d) subsequently sintering the resulting green body which has been freed of binder in this way.

19. The process according to claim 10 wherein the subsequently heating c) takes place for from 0.3 to 6 hours.

20. The process according to claim 17 wherein the subsequently heating c) takes place for from 0.3 to 6 hours.
